(19) United States
(12) Patent Application Publication
(10) Pub. No.: US 2024/0383535 A1
(43) Pub. Date: Nov. 21, 2024

(54) VEHICLE SIDE STRUCTURE

(71) Applicant: TOYOTA JIDOSHA KABUSHIKI KAISHA, Toyota-shi (JP)

(72) Inventors: Takeaki NAKAJIMA, Toyota-shi (JP); Kazuhiko Mutoh, Toyota-shi (JP); Shigenobu Miyachi, Nisshin-shi (JP)

(73) Assignee: TOYOTA JIDOSHA KABUSHIKI KAISHA, Tolyota-shi (JP)

(21) Appl. No.: 18/443,460

(22) Filed: Feb. 16, 2024

(30) Foreign Application Priority Data
May 18, 2023 (JP) 2023-082470

(51) Int. Cl. B62D 25/04; E05D 11/00

(52) U.S. Cl. CPC B62D 25/04; E05D 11/00; E05D 2011/009; E05Y 2600/63; E05Y 2900/531

(57) ABSTRACT

The hinge retainer of the vehicle side structure includes a front standing wall portion that is superimposed on an inner surface of a front wall portion of the A-pillar lower reinforcement, a side standing wall portion that is integrally provided so as to be orthogonal to the front standing wall portion and is superimposed on an inner surface of a side wall portion of the A-pillar lower reinforcement, and a top wall portion that is integrally provided so as to bridge from an upper side of the front standing wall portion to an upper side of the side standing wall portion.

### CROSS-REFERENCE TO RELATED APPLICATION

This application claims priority to Japanese Patent Application No. 2023-082470 filed on May 18, 2023, incorporated herein by reference in its entirety.

### BACKGROUND

### 1. Technical Field

The present disclosure relates to a vehicle side structure.

### 2. Description of Related Art

For example, Japanese Unexamined Patent Application Publication No. 2014-118009 (JP 2014-118009 A) describes that, when a front wheel is retracted by small overlap collision and a wheel collides with a left hinge pillar, deformation of the left hinge pillar in a vehicle inner direction is suppressed by compressively deforming the left hinge pillar to absorb energy, and guiding the front wheel to the outside of a vehicle by an inclined portion toward the outside of the vehicle.

### SUMMARY

In JP 2014-118009 A, at the time of small overlap collision, a front standing wall portion of the left hinge pillar with which the front wheel collides is bent prior to a rear standing wall portion, and in the process of continuing to receive the collision load from the front wheel, while a left door hinge attached to the left hinge pillar is rotated clockwise in a top view, an amount by which the left hinge pillar is pushed in the vehicle inner direction is increased.

In view of such circumstances, the present disclosure provides a vehicle side structure capable of reducing the amount by which the A-pillar lower is pushed toward the inside of a vehicle cabin by the collision load from the front wheel during small overlap collision.

A vehicle side structure according to an aspect of the present disclosure includes:
an A-pillar lower reinforcement of an A-pillar lower;
a side member outer overlapped with an outside of the A-pillar lower reinforcement;
a hinge retainer attached to an inside of the A-pillar lower reinforcement; and
a door hinge attached to an outside of the hinge retainer, in which
the hinge retainer includes a front standing wall portion overlapped with an inner surface of a front wall portion of the A-pillar lower reinforcement, a side standing wall portion integrally provided so as to be orthogonal to the front standing wall portion and overlapped with an inner surface of a side wall portion of the A-pillar lower reinforcement, and a top wall portion integrally provided so as to extend from an upper side of the front standing wall portion to an upper side of the side standing wall portion.

According to this configuration, the front proof stress of the hinge retainer is larger than the rear proof stress thereof. Therefore, when the front wheel is retreated by the small overlap collision and the wheel collides with the front portion of the A-pillar lower, a collision load is input to the front wall portion of the side member outer and the front wall portion of the A-pillar lower reinforcement overlapped with the inside thereof.

The front standing wall portion of the hinge retainer is overlapped with the inside of the front wall portion of the A-pillar lower reinforcement. Therefore, in accordance with the input of the collision load, the rear wall portion of the side member outer and the rear wall portion of the A-pillar lower reinforcement are bent before the front wall portion of the side member outer and the front wall portion of the A-pillar lower reinforcement are bent, and the door hinge is rotated counterclockwise in a top view. As a result, the amount by which the A-pillar lower is pushed toward the inside of the vehicle cabin is reduced.

According to the present disclosure, it is possible to reduce the amount by which the A-pillar lower is pushed toward the inside of the vehicle cabin by the collision load from the front wheels at the time of the small overlap collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a lower portion of an A-pillar on a left side of a vehicle in accordance with an embodiment of a vehicle side structure according to the present disclosure;

FIG. 2 is a perspective view showing a state in which the side member outer is omitted in FIG. 1;

FIG. 3A is a cross-sectional view showing an early stage of a small overlap impact;

FIG. 3B is a cross-sectional view showing the steps following FIG. 3A;

FIG. 4A is a cross-sectional view showing the steps following FIG. 3B;

FIG. 4B is a cross-sectional view showing the steps following FIG. 4A;

FIG. 5A is a cross-sectional view of a vehicle-side structure according to the present disclosure;

FIG. 5B is a cross-sectional view of a vehicle-side structure according to the present disclosure;

FIG. 6A is a cross-sectional view of a vehicle-side structure according to another modification of the present disclosure; and

FIG. 6B is a cross-sectional view showing another modification of the vehicle-side structure according to the present disclosure.

### DETAILED DESCRIPTION OF EMBODIMENTS

Hereinafter, the best mode for carrying out the present disclosure will be described in detail below with reference to the accompanying drawings.

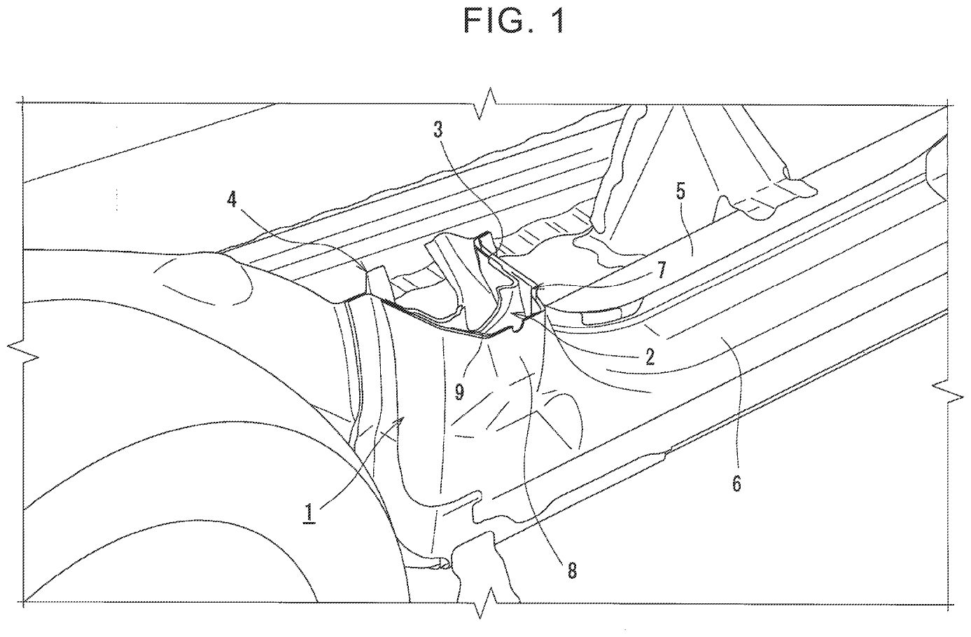

FIGS. 1 to 4B show an embodiment of the present disclosure. In the drawings, the vehicle front direction is indicated by Fr, and the vehicle left direction is indicated by Lh.

FIG. 1 is a perspective view of an A-pillar lower 1 on a left side of a vehicle in a cross-section according to an embodiment of a vehicle side structure according to the present disclosure.

Inside the A-pillar lower inner 2, the A-pillar lower inner reinforcement 3 is arranged so as to be superimposed.

Both the A-pillar lower inner 2 and the A-pillar lower inner reinforcement 3 have a substantially U-shaped cross section along the vehicle left-right direction and are formed to have substantially the same size.

The A-pillar lower inner reinforcement 3 is attached to the cowl side panel 4 by, for example, a bolt. The cowl side panel 4 is attached to the rocker inner 5 by, for example, a bolt. The rocker inner 5 is connected to the rocker outer 6 by, for example, spot welding.

An A-pillar lower reinforcement 7 is disposed outside the A-pillar lower inner 2. The side member outer 8 is arranged to be superimposed on the outside of the A-pillar lower reinforcement 7.

Both the A-pillar lower reinforcement 7 and the side member outer 8 have a substantially U-shaped cross section along the vehicle left-right direction and have substantially the same size, and have front wall portions 71 and 81, side wall portions 72 and 82, and rear wall portions 73 and 83.

The dimensions from the side wall portions 72 and 82 of each of the A-pillar lower reinforcement 7 and the side member outer 8 to the opening are set larger than the dimensions from the side wall portions (not shown) of each of the A-pillar lower inner 2 and the A-pillar lower inner reinforcement 3 to the opening.

A hinge retainer 9 is attached to the outside of the A-pillar lower inner 2. The hinge retainer 9 is disposed in a space spaced apart from the side wall portion (not shown) of the A-pillar lower inner 2 to the side wall portion 72 of the A-pillar lower reinforcement 7.

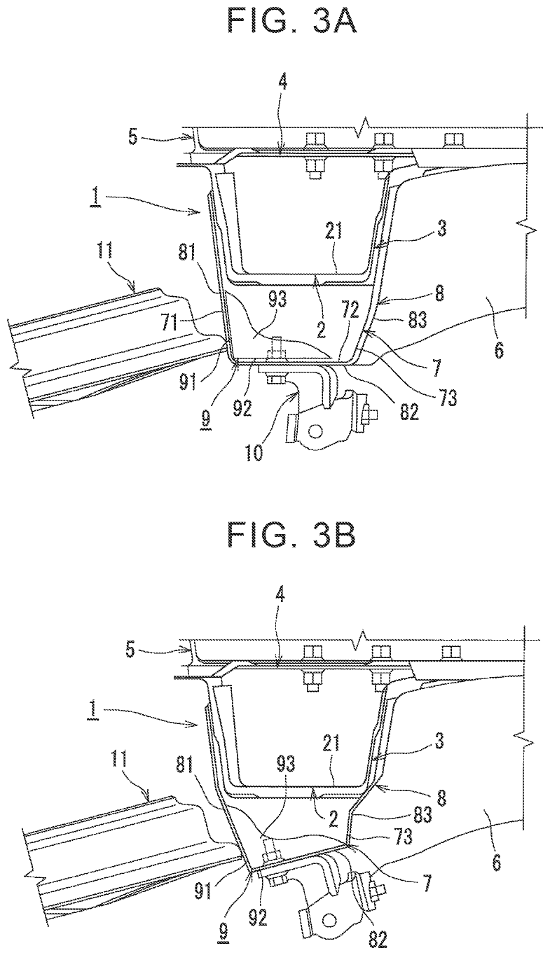

A left door (not shown) is attached to the hinge retainer 9 via a door hinge 10, as shown in FIGS. 3A and 3B.

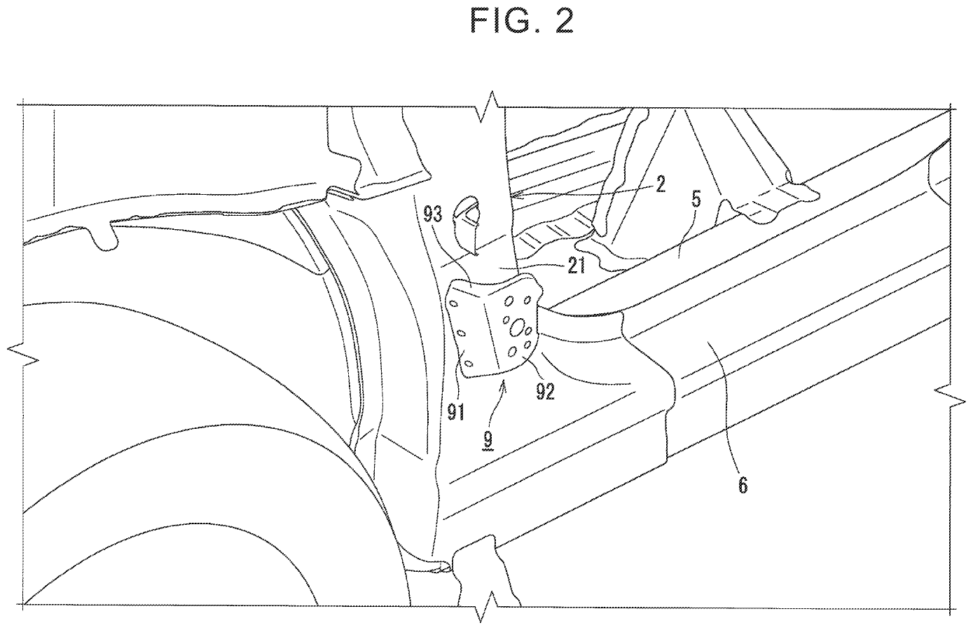

FIG. 2 is a perspective view showing a state in which the side member outer 8 is omitted in FIG. 1. The hinge retainer 9 includes a front standing wall portion 91 on the vehicle front side, a side standing wall portion 92 on the side of the vehicle side, and a top wall portion 93.

The front standing wall portion 91 and the side standing wall portion 92 are integrally connected to each other so as to be orthogonal to each other. An attachment piece (not shown) for attachment to the side wall portion 21 of the A-pillar lower inner 2 is provided at an inner end of the front standing wall portion 91. Although not shown in detail, the mounting piece is bolted to the A-pillar lower inner 2, for example.

A door hinge 10 is bolted to the side standing wall portion 92, for example. The top wall portion 93 is provided so as to extend from the upper side of the front standing wall portion 91 to the upper side of the side standing wall portion 92, thereby contributing to increasing the strength of the hinge retainer 9. The top wall portion 93, The hinge retainer 9 is superposed on the inner surface of the front wall portion 71 of the A-pillar lower reinforcement 7 in which the front standing wall portion 91 is superposed on the inner side of the side member outer 8, and the side standing wall portion 92 is superposed on the inner surface of the side wall portion 72 of the A-pillar lower reinforcement 7. As a result, the front proof stress of the A-pillar lower 1 becomes larger than the rear proof stress.

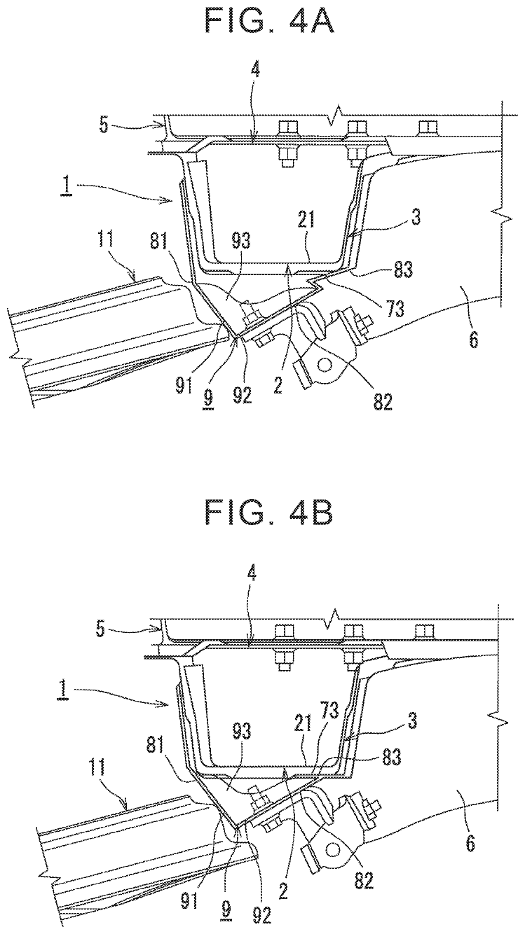

FIG. 3A is a cross-sectional view showing an early stage of small overlap impact, and FIG. 3B is a cross-sectional view showing a stage subsequent to FIG. 3A. FIG. 4A is a cross-sectional view showing a stage subsequent to FIG. 3B, and FIG. 4B is a cross-sectional view showing a stage subsequent to FIG. 4A.

Referring to FIGS. 3A, 3B, 4A, and 4B, explaining the state at the time of small overlap collision.

As shown in FIG. 3A, when the front wheels retreat due to the small overlap collision and the wheel 11 collides with the front portion of the A-pillar lower 1, a collision load is inputted to the front wall portion 81 of the side member outer 8 and the front wall portion 71 of the A-pillar lower reinforcement 7 superimposed on the inside thereof.

Since the front standing wall portion 91 of the hinge retainer 9 is superposed on the inner surface of the front wall portion 71 of the A-pillar lower reinforcement 7, the rear wall portion 83 of the side member outer 8 and the rear wall portion 73 of the A-pillar lower reinforcement 7 are bent as shown in FIGS. 3B, 4A, and 4B, and the door hinge 10 is rotated counterclockwise in the top view, before the front wall portion 81 of the side member outer 8 and the front wall portion 71 of the A-pillar lower reinforcement 7 are bent in accordance with the input of the collision load. As a result, the amount by which the A-pillar lower 1 is pushed into the vehicle cabin is reduced.

Thereafter, if the input of the collision load from the wheel 11 continues, the door hinge 10 tends to be peeled off from the hinge retainer 9, so that the A-pillar lower 1 is less likely to be pushed into the vehicle cabin.

According to the embodiment to which the present disclosure is applied as described above, it is possible to reduce the amount by which the A-pillar lower 1 is pushed toward the inside of the vehicle cabin by the collision load from the wheel 11 of the front wheel at the time of the small overlap collision.

The present disclosure is not limited to the above embodiment, and can be modified as appropriate in the scope of claims and a range equivalent to the scope of claims.

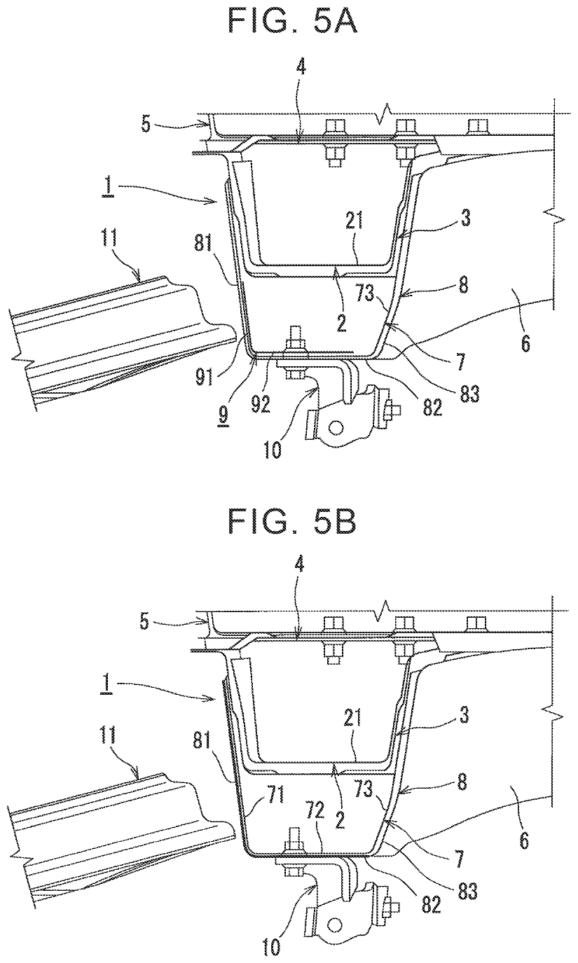

(1) For example, a modification of the present disclosure is shown in FIGS. 5A and 5B. In the modification shown in FIG. 5A, the top wall portion 93 of the hinge retainer 9 of the above-described embodiment is eliminated, and the front standing wall portion 91 and the side standing wall portion 92 of the hinge retainer 9 are made thick so as to prevent the hinge retainer from being bent.

In the modification shown in FIG. 5B, the hinge retainer 9 of the above-described embodiment is eliminated, and the entire side member outer 8 is made thick so as to prevent bending.

In addition to the configuration for making the entire side member outer 8 thick, in order to hardly bend the front wall portion 81 and the side wall portion 82 of the side member outer 8, or formed of a high-strength material, although not shown, it is conceivable that the inner surface of the front wall portion 81 and the side wall portion 82 of the side member outer 8 is joined so as to overlap the reinforcing material, or a bead is provided in the front wall portion 81 and the side wall portion 82 of the side member outer 8.

Even in the above-described modification, an operation and an effect comparable to those of the above-described embodiment can be obtained.

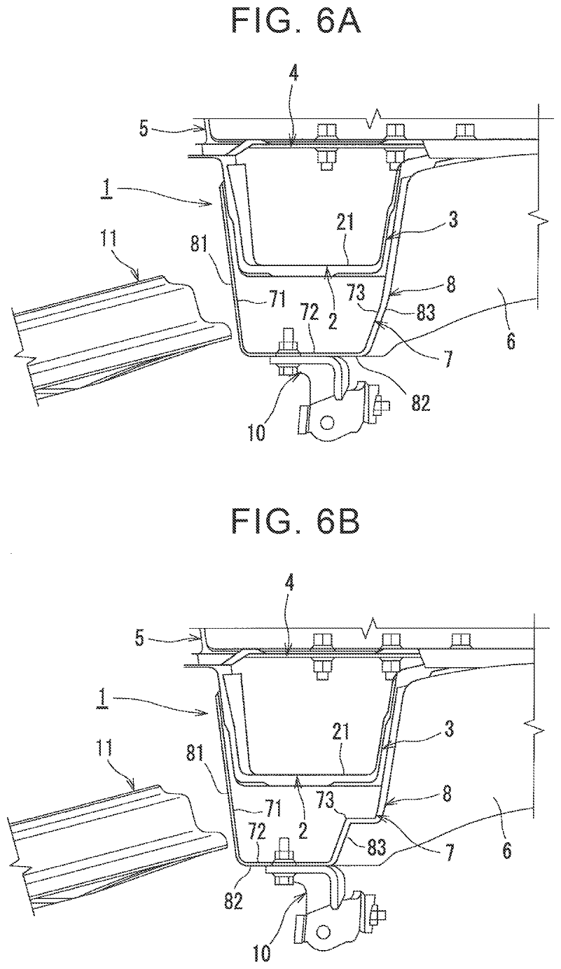

(2) For example, in FIGS. 6A and 6B, another modification of the present disclosure is shown. The modification shown in FIG. 6A is configured so that the hinge retainer 9 of the above-described embodiment is eliminated, and the rear wall portion 73 of the A-pillar lower reinforcement 7 and the rear wall portion 83 of the side member outer 8 are made thin so as to be easily bent.

In addition to the configuration in which the rear wall portion 73 of the A-pillar lower reinforcement 7 and the rear wall portion 83 of the side member outer 8 are made thin, in order to easily bend the rear wall portion 73 of the A-pillar lower reinforcement 7 and the rear wall portion 83 of the side member outer 8, it is conceivable to form a low-strength material or to make a hole in the rear wall portion 73 of the A-pillar lower reinforcement 7 and the rear wall portion 83 of the side member outer 8, although not shown.

In the modification shown in FIG. 6B, the hinge retainer 9 of the above-described embodiment is eliminated, and the rear wall portion 73 of the A-pillar lower reinforcement 7 and the rear wall portion 83 of the side member outer 8 are bent in a crank-shaped manner so as to be easily bent.

Even in the above-described modification, an operation and an effect comparable to those of the above-described embodiment can be obtained.

The present disclosure can be suitably used for a vehicle side structure.

What is claimed is:

1. A vehicle side structure, comprising:
an A-pillar lower reinforcement of an A-pillar lower;
a side member outer overlapped with an outside of the A-pillar lower reinforcement;
a hinge retainer attached to an inside of the A-pillar lower reinforcement; and
a door hinge attached to an outside of the hinge retainer, wherein the hinge retainer includes a front standing wall portion overlapped with an inner surface of a front wall portion of the A-pillar lower reinforcement, a side standing wall portion integrally provided so as to be orthogonal to the front standing wall portion and overlapped with an inner surface of a side wall portion of the A-pillar lower reinforcement, and a top wall portion integrally provided so as to extend from an upper side of the front standing wall portion to an upper side of the side standing wall portion.
